(19) United States
(12) Patent Application Publication
(10) Pub. No.: US 2018/0018726 A1
(43) Pub. Date: Jan. 18, 2018

(54) METHOD, APPARATUS, AND PROGRAM PRODUCT FOR DIGITAL REUSABLE GROCERY BAGS WITH AUGMENTED REALITY AND CONSUMER OFFERS

(71) Applicant: BRANDBAGS, LLC, Los Angeles, CA (US)

(72) Inventors: Matthew CALLINAN, Los Angeles, CA (US); Martin LAITRE, Los Angeles, CA (US); Noah BREMEN, Los Angeles, CA (US); Jeff BUCHBINDER, Los Angeles, CA (US); Lee PFEIFER, Los Angeles, CA (US)

(21) Appl. No.: 15/649,155

(22) Filed: Jul. 13, 2017

Related U.S. Application Data
(60) Provisional application No. 62/361,706, filed on Jul. 13, 2016.

(51) Int. Cl. G06Q 30/06; G06K 9/22; G06K 7/14; G06Q 30/02; B65D 33/00

(52) U.S. Cl. CPC G06Q 30/0623; G06Q 30/0212; G06Q 30/0201; B65D 33/004; G06K 7/1417; G06K 9/22

(57) ABSTRACT

A polyethylene reusable grocery bag and/or polyethylene reusable retail bag linked to a proprietary Content Management System (CMS) that delivers multiple elements of easy-to-access, customer-driven value. Bag value includes and integrates large-banner bag advertising with bag digital coupons, bag augmented reality (A/R) video content, bag digital content, and bag peel-off coupons. Digital and A/R bag value is accessed by the consumer via QR code reader and/or an A/R application. CMS delivers bag value to the consumer in various configurations and process flows. CMS can reprogram and exchange the bag digital and A/R value using the same QR code or bag image. CMS can automate the brands response offer to each individual based on what the download and redeem (a 1-to-1 marketing engine). Bag value is not necessarily delivered all-inclusive on all bag products.

### CROSS-REFERENCE TO RELATED APPLICATION

This application claims priority to provisional application 62/170,326, filed Jul. 13, 2016.

### FIELD OF THE INVENTION

The invention relates to the field of delivering information to a retail consumer.

### BACKGROUND OF THE INVENTION

Reusable polyethylene grocery and retail bags can be valued by customers and, if able to provide and collect information, would be of additional value for retailers.

### SUMMARY OF THE INVENTION

The present invention comprises a polyethylene reusable grocery bag and/or polyethylene reusable retail bag linked to a proprietary Content Management System (CMS) that delivers multiple elements of easy-to-access, customer-driven value. Bag value includes and integrates large-banner bag advertising with bag digital coupons, bag augmented reality (A/R) video content, bag digital content, and bag peel-off coupons. Digital and A/R bag value is accessed by the consumer via QR code reader and/or an A/R application. CMS delivers bag value to the consumer in various configurations and process flows.

### BRIEF DESCRIPTION OF THE DRAWINGS

FIG. 1 is a flow chart illustrating the consumer information flow of the present invention.

FIG. 2 is a flow chart illustrating the CMS information flow of the present invention.

FIG. 3 is an illustration of exemplar reusable polyethylene retail bags linked to the Content Management System (CMS) of the present invention.

FIGS. 4-8 are screenshots of a downloadable app of the present invention that may be downloaded by the consumer to a smartphone device to allow the smartphone to capture an image of the QR code or bag image and to access data from the CMS linked to the QR code or bag image.

FIG. 9 is an illustration of exemplar bags of the present invention used to capture emails, birthdates, zip codes, and phone numbers.

### DETAILED DESCRIPTION OF THE INVENTION

In one embodiment, the present invention comprises a polyethylene reusable grocery bag and/or polyethylene reusable retail bag linked to a proprietary Content Management System (CMS) that delivers multiple elements of easy-to-access, customer-driven value. Bag value includes and integrates large-banner bag advertising with bag digital coupons, bag augmented reality (A/R) video content, bag digital content, and bag peel-off coupons. Digital and A/R bag value is accessed by the consumer via QR code reader and/or an A/R application. CMS delivers bag value to the consumer in various configurations and process flows. CMS can reprogram and exchange the bag digital and A/R value using the same QR code or bag image. CMS can automate the brands response offer to each individual based on what the download and redeem (a 1-to-1 marketing engine). Bag value is not necessarily delivered all-inclusive on all bag products.

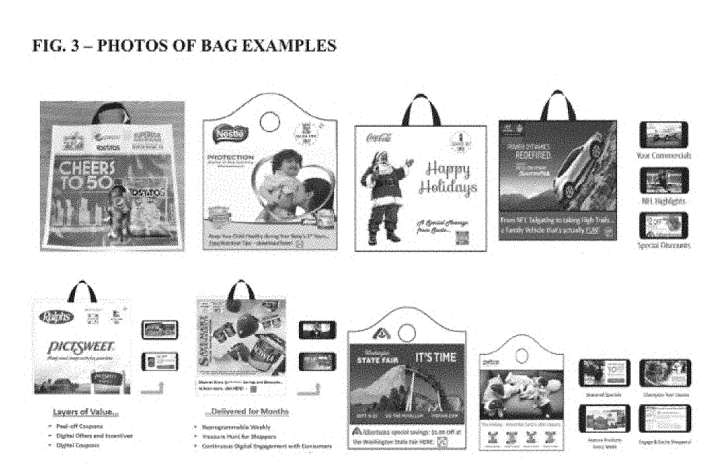

In another embodiment, the present invention comprises a system and method of delivering information to a retail consumer including providing the consumer a polyethylene reusable grocery bag and/or polyethylene reusable retail bag, the bag having a QR code or bag image displayed on the exterior surface. Exemplar bags are illustrated in FIG. 3.

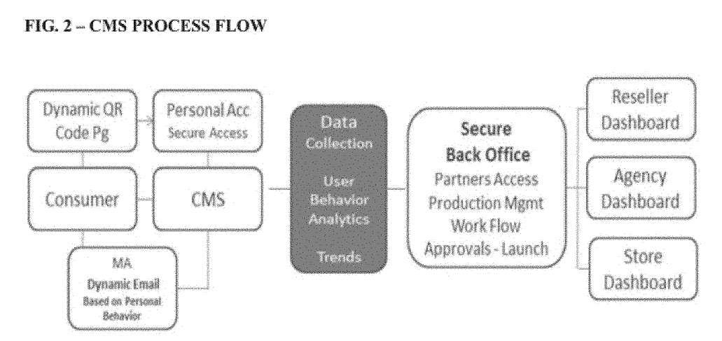

The present invention further comprises a proprietary Content Management System (CMS) accessible by the smartphone over a communication network, the CMS programmed to link the QR code or bag image to stored bag digital coupons, bag augmented reality (A/R) video content, and bag digital content. The CMS information flow is illustrated in FIG. 2.

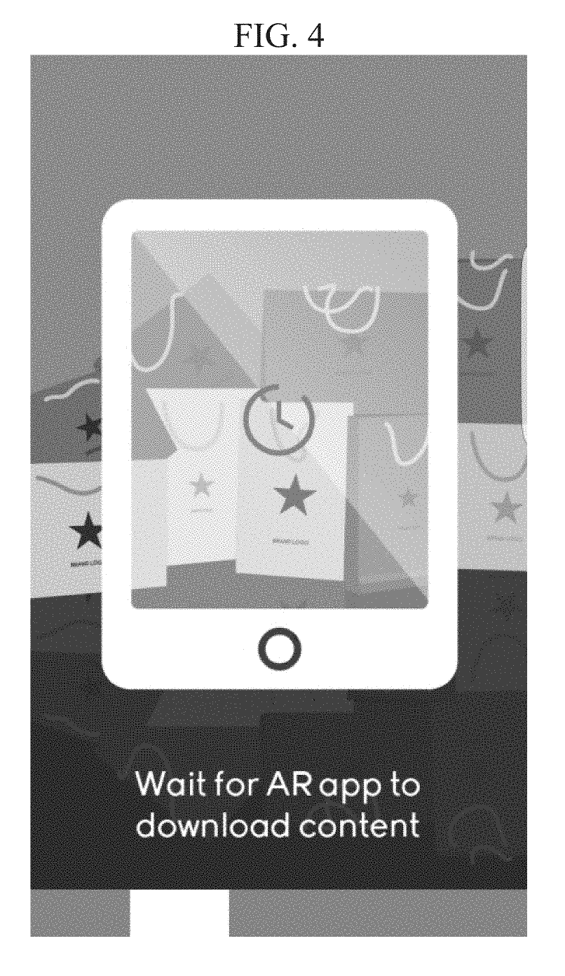

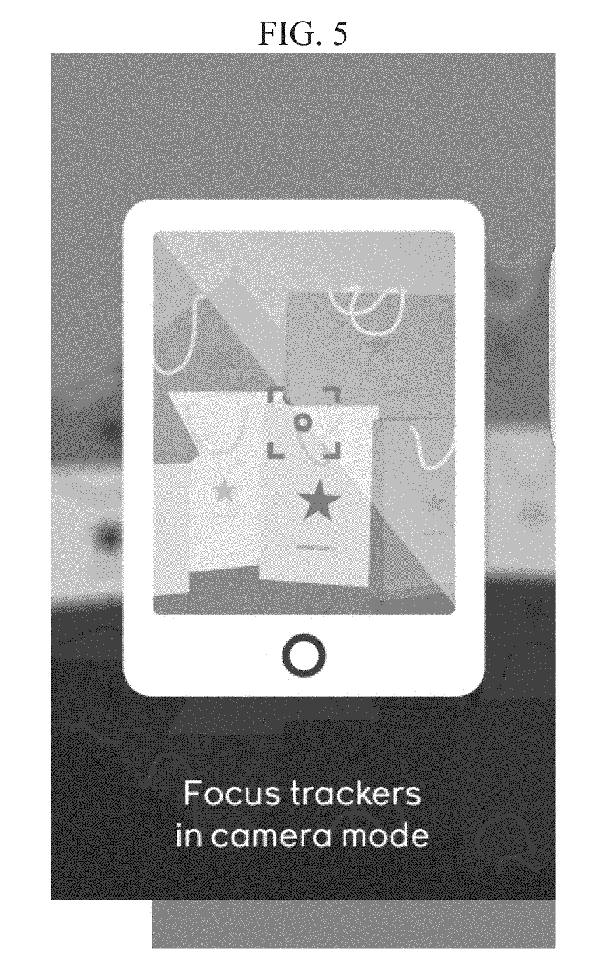

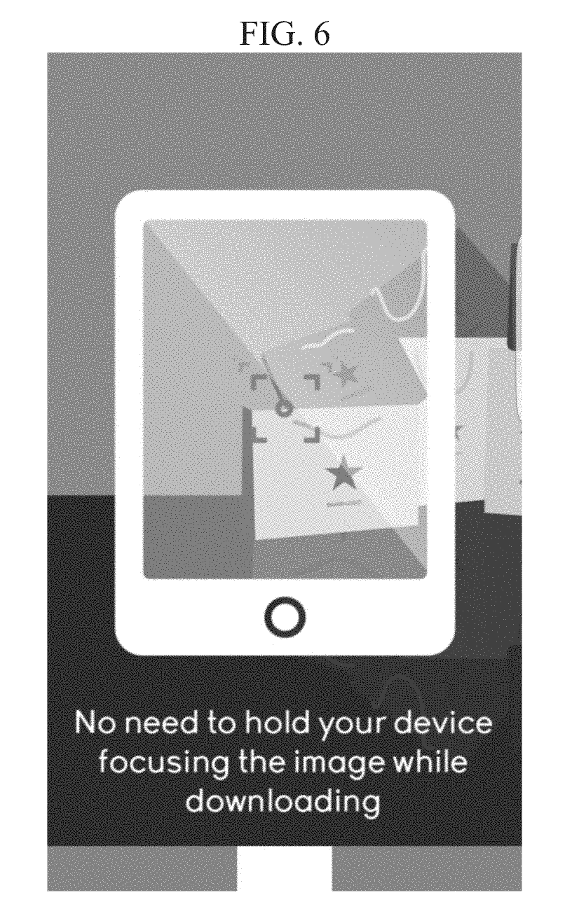

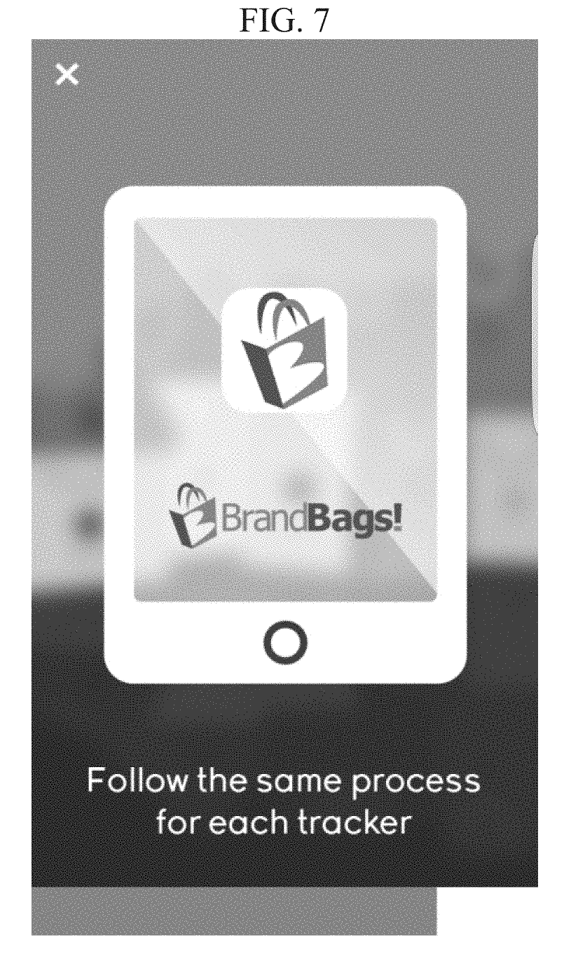

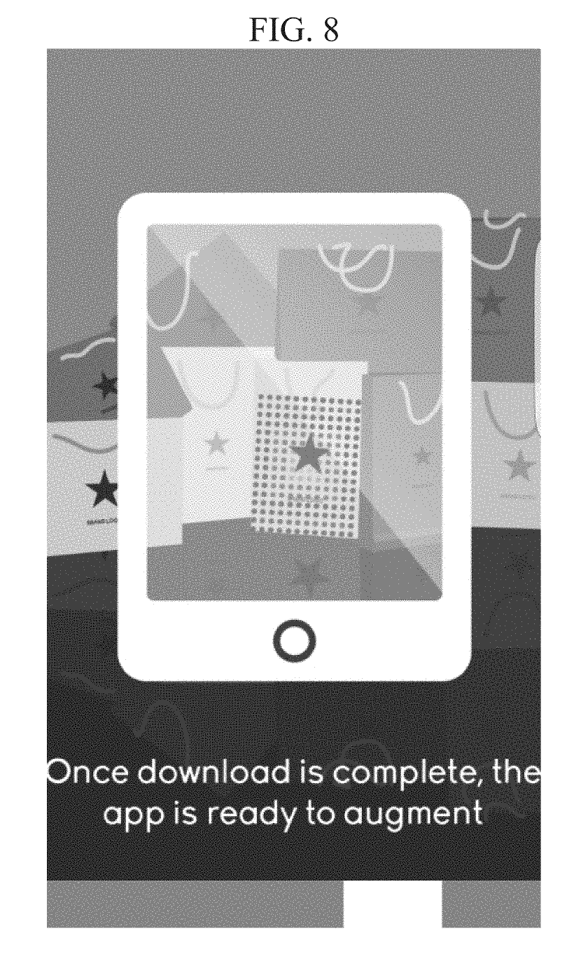

The CMS can deliver such stored data to the smartphone over a communication network by providing a downloadable app that may be downloaded by the consumer to a smartphone device, the app programmed to allow the smartphone to capture an image of the QR code or bag image and to access data from the CMS linked to the QR code or bag image. The operation of the app is illustrated in FIGS. 4-8.

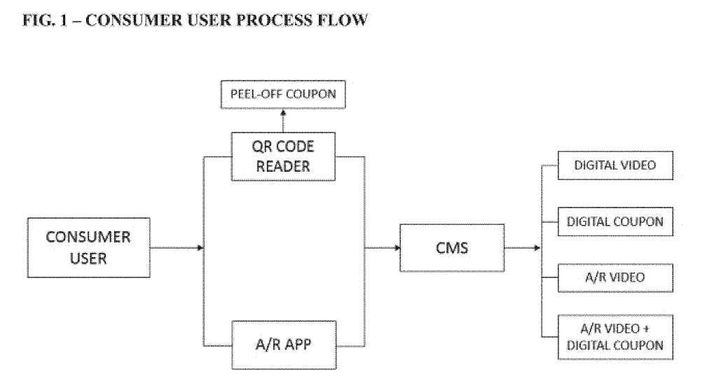

Thus, the consumer uses the smartphone to capture an image of the QR code or bag image and to access the linked data from the CMS. The consumer information flow is illustrated in FIG. 1. Further, the CMS may be programmed to provide communications to the consumer based upon inputs to the smartphone made by the consumer in response to the data.

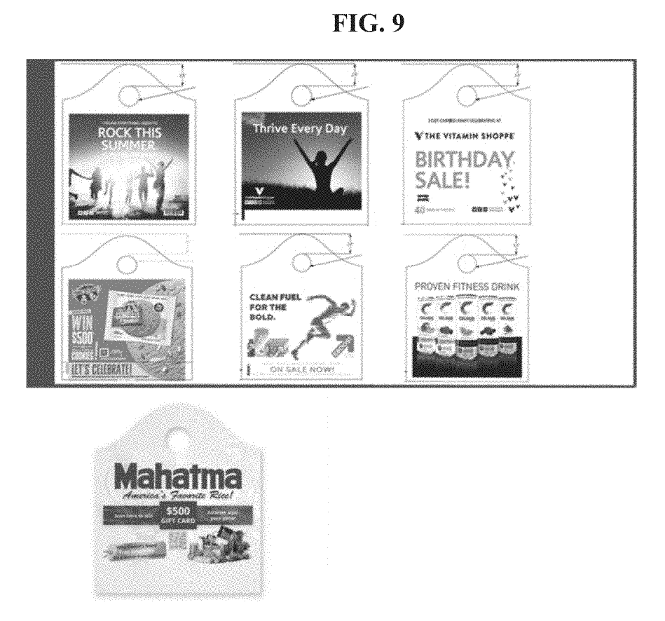

By offering a chance to win prizes, Additional Data Collection and contests can be implemented on the bag of the present invention. The additional component to the bag's technology is by directing the QR Code component to a landing page or lead capture site where any number of customizable data points can be entered. An exemplar bag used to capture emails, birthdates, zip codes, and phone numbers is displayed in FIG. 9.

A customized sizing aspect to the invention is has been developed specifically for Grocery pickup use. Dimensions of an exemplar bag are 39×17×14 and 2.50 mil thick.

We claim:

1. A method of delivering information to a retail consumer comprising the steps of:
providing the consumer a polyethylene reusable grocery bag or polyethylene reusable retail bag, the bag having a QR code or bag image displayed on the exterior surface,
providing a proprietary Content Management System (CMS) accessible by the smartphone over a communication network, the CMS programmed to link the QR code or bag image to stored bag digital coupons, bag augmented reality (A/R) video content, and bag digital content, and to deliver such stored data to the smartphone over a communication network;
providing a downloadable app that may be downloaded by the consumer to a smartphone device, the app programmed to allow the smartphone to capture an image of the QR code or bag image and to access data from the CMS linked to the QR code or bag image; and
allowing the consumer to use the smartphone to capture an image of the QR code or bag image to access the linked data from the CMS.

2. The method of claim 1 wherein the CMS is programmed to provide communications to the consumer based upon inputs to the smartphone made in response to the data.

3. The method of claim 2 wherein the CMS is programmed to receive data comprising emails, birthdates, zip codes, or phone numbers from the consumer made in response to the communications.

4. The method of claim 3 wherein the CMS is programmed to send contest information in the communications to the consumer to prompt the input of data comprising emails, birthdates, zip codes, or phone numbers.
